(19) United States
(12) Patent Application Publication
(10) Pub. No.: US 2026/0186819 A1
(43) Pub. Date: Jul. 2, 2026

(54) MICROKERNEL-BASED EVENT HANDLING METHOD AND APPARATUS

(71) Applicant: Black Sesame Technologies Co., Ltd., Wuhan (CN)

(72) Inventors: Zhuo Huang, Chengdu (CN); Xin Wang, Wuhan (CN)

(21) Appl. No.: 19/431,799

(22) Filed: Dec. 23, 2025

(30) Foreign Application Priority Data
Jan. 2, 2025 (CN) 202510005439.1

(51) Int. Cl. G06F 9/455

(52) U.S. Cl. CPC G06F 9/45558; G06F 2009/45575

(57) ABSTRACT

The present disclosure provides a microkernel-based event handling method and apparatus. A virtual machine is embedded in a microkernel, and the method includes: in response to detecting a preset trigger event during running of a target application program in a user mode, switching from the user mode to a kernel mode and acquiring a bytecode associated with the preset trigger event, where the bytecode is a functional code pre-written into a shared code region in the user mode, and the functional code is a code corresponding to partial functions in the target application program; and controlling the virtual machine to execute the bytecode, and writing an execution result of the preset trigger event into a shared data region, to make the execution result be read from the shared data region in the user mode after switching to the user mode. The method may improve handling efficiency of a microkernel system

### RELATED APPLICATION

This application claims the benefit under 35 U.S.C. § 119(a) of the filing date of Chinese Patent Application No. 202510005439.1, filed in the Chinese Patent Office on Jan. 2, 2025. The disclosure of the foregoing application is herein incorporated by reference in its entirety.

### TECHNICAL FIELD

The present disclosure relates to a computer technology field, and more particularly, to a microkernel-based event handling method and apparatus.

### BACKGROUND

In a microkernel, address space boundaries exist among multiple threads generated by a target application program running in a user mode. Therefore, communication between threads currently relies on Inter-Process Communication (IPC). Completing a single communication requires following three steps: switching to a kernel mode, message passing, and switching back to the user mode. Further, communication between services is very frequent in a microkernel system, and requires multiple IPC.

### SUMMARY

Embodiments of the present disclosure provide a microkernel-based event handling method and apparatus, which may improve handling efficiency of a microkernel system.

In a first aspect of the present disclosure, a microkernel-based event handling method is provided, where a microkernel is embedded with a virtual machine, and the method includes: in response to detecting a preset trigger event during running of a target application program in a user mode, switching from the user mode to a kernel mode and acquiring a bytecode associated with the preset trigger event, where the bytecode is a functional code pre-written into a shared code region in the user mode, and the functional code is a code corresponding to partial functions in the target application program; and controlling the virtual machine to execute the bytecode, and writing an execution result of the preset trigger event into a shared data region, to make the execution result be read from the shared data region in the user mode after switching to the user mode.

In a second aspect of the present disclosure, a microkernel-based event handling apparatus is provided, where a microkernel is embedded with a virtual machine, and the apparatus includes: an acquiring circuitry configured to: in response to detecting a preset trigger event during running of a target application program in a user mode, switch from the user mode to a kernel mode and acquire a bytecode associated with the preset trigger event, where the bytecode is a functional code pre-written into a shared code region in the user mode, and the functional code is a code corresponding to partial functions in the target application program; and a controlling circuitry configured to: control the virtual machine to execute the bytecode, and write an execution result of the preset trigger event into a shared data region, to make the execution result be read from the shared data region in the user mode after switching to the user mode.

In a third aspect of the present disclosure, an electronic device including a memory and a processor is provided, where the memory has a computer program stored thereon, and when the processor executes the computer program, the method according to the first aspect is implemented.

In a fourth aspect of the present disclosure, a computer-readable storage medium having a computer program stored thereon is provided, where when the computer program is executed by a processor, the method according to the first aspect is implemented.

In a fifth aspect of the present disclosure, a computer program product including a computer program is provided, where when the computer program is executed by a processor, the method according to the first aspect is implemented.

According to the microkernel-based event handling method and apparatus provided in the embodiments of the present disclosure, by pre-writing the code corresponding to partial functions of the target application program into the shared code region, the code is executed by the virtual machine embedded in the microkernel in the kernel mode. That is, some functions that were originally executed in the user mode change to be executed in the kernel mode, thereby reducing frequent switching between the user mode and the kernel mode, and the number of communication times, which improves handling efficiency of the microkernel system.

### BRIEF DESCRIPTION OF THE DRAWINGS

To more clearly describe technical solutions in the embodiments of the present disclosure or in existing techniques, drawings used in the embodiments are briefly introduced below. Obviously, the drawings described below are only some embodiments of the present disclosure. Those skilled in the art can obtain other drawings based on these drawings without creative effort.

FIG. 1 is a flow chart of a microkernel-based event handling method provided in an embodiment of the present disclosure;

FIG. 2 is a system architecture diagram applicable to an embodiment of the present disclosure;

FIG. 3 is an execution flow chart based on an active invocation interface according to an embodiment of the present disclosure;

FIG. 4 is a schematic diagram of an active invocation event according to an embodiment of the present disclosure;

FIG. 5 is a schematic diagram of handling a notification message according to an embodiment of the present disclosure;

FIG. 6 is a schematic diagram of handling a notification message according to an embodiment of the present disclosure;

FIG. 7 is a schematic diagram of a drive thread optimizing an IPC communication process according to an embodiment of the present disclosure;

FIG. 8 is a flow chart of configuring a Wasm virtual machine according to an embodiment of the present disclosure;

FIG. 9 is a flow chart of clearing existing configuration of a Wasm virtual machine according to an embodiment of the present disclosure;

FIG. 10 is a flow chart of a microkernel-based event handling method provided in an embodiment of the present disclosure;

FIG. 11 is a block diagram of a microkernel-based event handling apparatus provided in an embodiment of the present disclosure; and

FIG. 12 is a block diagram of an electronic device provided in an embodiment of the present disclosure.

### DETAILED DESCRIPTION

Technical solutions in the embodiments of the present disclosure are clearly and completely described below with reference to accompanying drawings. Obviously, the described embodiments are only some embodiments of the present disclosure, but not all embodiments. Based on the embodiments of the present disclosure, all other embodiments acquired by those skilled in the art without creative effort are within the scope of the present disclosure.

A brief explanation of how to reduce time of microkernel scheduling in related technologies is provided below.

To address the aforementioned issues, during a thread migration IPC, the microkernel does not block user-mode threads, but allows the user-mode threads to execute kernel-mode codes. Throughout the thread migration IPC process, kernel-mode threads are not awakened. Therefore, the microkernel avoids a full context switch, instead only switching system states related to request handling, such as an address space (a page table).

Thread migration IPC reduces the time of microkernel scheduling, that is, improving handling efficiency of a microkernel system by optimizing the IPC process, but effect on efficiency improvement is limited.

In view of this, the embodiments of the present disclosure provide a novel approach to improve the handling efficiency of the microkernel system by reducing a number of communications.

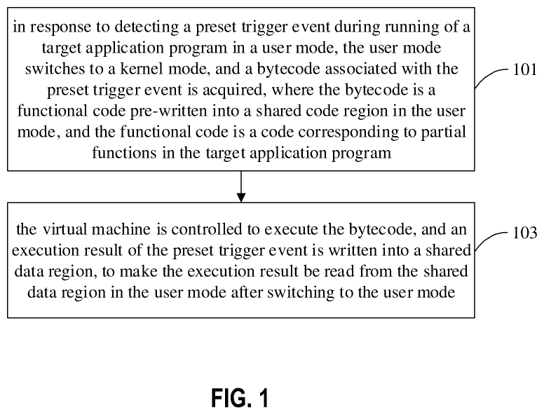

FIG. 1 is a flow chart of a microkernel-based event handling method provided in an embodiment of the present disclosure. Referring to FIG. 1, the microkernel-based event handling method in the embodiment of the present disclosure may include 101 and 103.

In 101, in response to detecting a preset trigger event during running of a target application program in a user mode, the user mode switches to a kernel mode, and a bytecode associated with the preset trigger event is acquired, where the bytecode is a functional code pre-written into a shared code region in the user mode, and the functional code is a code corresponding to partial functions in the target application program.

In 103, the virtual machine is controlled to execute the bytecode, and an execution result of the preset trigger event is written into a shared data region, to make the execution result be read from the shared data region in the user mode after switching to the user mode.

From above, in the embodiment of the present disclosure, by pre-writing the code corresponding to partial functions of the target application program into the shared code region, the code is executed by the virtual machine embedded in the microkernel in the kernel mode. That is, some functions that were originally executed in the user mode change to be executed in the kernel mode, thereby reducing frequent switching between the user mode and the kernel mode, and the number of communication times, which improves handling efficiency of the microkernel system.

Each step in the above method and effects that can be produced are described in detail below with reference to embodiments.

The microkernel-based event handling method provided in the embodiment of the present disclosure is implemented by a processor. When the processor executes the target application program, the target application program can be divided into a user mode and a kernel mode, i.e., threads existing in the user mode and threads existing in the kernel mode, based on a code type and a permission level of running. The two modes are used to distinguish permissions of the target application program and the microkernel.

The user mode refers to a running state of the target application program. In the user mode, the target application program requests services provided by an operating system through system invocation, such as a trigger event request sent in response to a trigger event.

The kernel mode refers to a running state of a microkernel of the operating system.

However, the user mode and the kernel mode are not completely independent running spaces. The target application program may require support from the operating system (i.e., the microkernel system) during running. This necessitates switching from the user mode to the kernel mode, where the operating system provides services. Conversely, the microkernel within the operating system may need to switch back to the user mode as needed, returning control to the target application program. The switching process involves saving and restoring processor states, context switching, and other operations, which requires underlying support from the operating system.

The context switching may be required when switching from the user mode to the kernel mode and when switching back from the kernel mode to the user mode.

To improve the handling efficiency of the microkernel system, in the present disclosure, the virtual machine is integrated into the microkernel. By extending the microkernel, the trigger event that is handled in the user mode is moved to the microkernel for handling. After the bytecode associated with the trigger event is acquired, the virtual machine embedded in the microkernel is controlled to execute the bytecode, and the execution result of the trigger event is written into the shared data region, to make the execution result be read from the shared data region in the user mode after switching to the user mode. This eliminates multiple times of switching between the user mode and the kernel mode when executing the trigger event in the user mode, thereby improving the handling efficiency of the microkernel system.

The microkernel system involved in the embodiments of the present disclosure includes, but is not limited to, seL4, L3, QNX, etc.

The virtual machine involved in the embodiments of the present disclosure includes, but is not limited to: a virtual machine that executes ebpf (extended Berkeley Packet Filter) bytecode, a virtual machine that executes Wasm (WebAssembly, a binary instruction format designed for a stack-based virtual machine) bytecode (hereinafter referred to as a Wasm virtual machine), a virtual machine that executes lua (a lightweight scripting language) bytecode, etc.

The following description uses SeL4 as the microkernel system, the Wasm virtual machine that executes Wasm bytecode as an example, and an embedded environment as a runtime environment of the Wasm virtual machine.

First, in conjunction with embodiments, the above step 101, i.e., “in response to detecting a preset trigger event during running of a target application program in a user mode, the user mode switches to a kernel mode, and a bytecode associated with the preset trigger event is acquired, where the bytecode is a functional code pre-written into a shared code region in the user mode, and the functional code is a code corresponding to partial functions in the target application program”, is described in detail below.

In the embodiment of the present disclosure, in response to the processor detecting the preset trigger event during the running of the target application program in the user mode, the user mode switches to the kernel mode, and the Wasm bytecode associated with the preset trigger event is acquired.

In the embodiment of the present disclosure, prior to detecting the preset trigger event during running of the target application program in the user mode, the method further includes following steps.

In a first step, in an embedded environment, there is no need for real-time injection of code in the user mode. Therefore, in the embedded environment, the injected code may be compiled into a Wasm file, and the Wasm file may be compiled into microkernel mirroring.

The Wasm file is generated by compiling the injected code using Software Development Kit (SDK) of a Wasm system interface on a host computer.

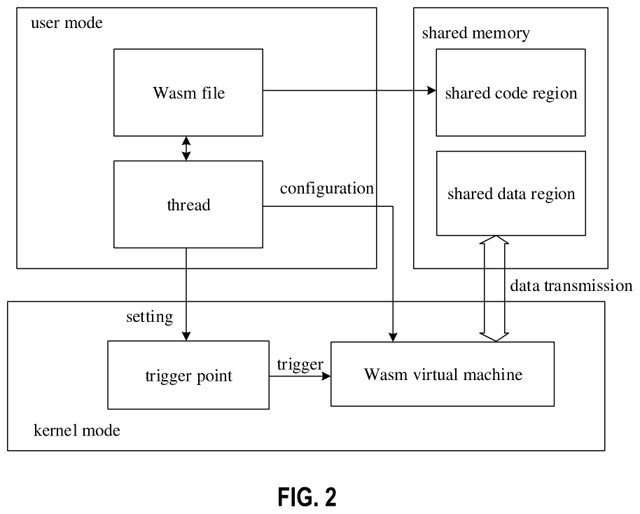

In a second step, after being read from the Wasm file in the user mode, the Wasm bytecode is copied to the shared code region (shown as “shared code region” in FIG. 2) in a shared memory (shown as “shared memory” in FIG. 2).

Before the first step, the method further includes: initializing a runtime environment of the Wasm virtual machine; creating a shared code region for the target application program, and writing the code corresponding to the partial functions in the target application program into the shared code region; and creating the shared data region for the target application program.

Specifically, the shared code region and the shared data region created for the target application program refers to the shared code region for storing Wasm bytecode allocated for normal operation of the target application program, and the shared data region for data interaction between the kernel mode and the user mode.

After the shared code region and the shared data region are created, permission of a shared code region object and permission of a shared data region object are acquired respectively. The permissions represent access rights of the user mode and the kernel mode to access the shared code region object and the shared data region object respectively.

In the embodiment of the present disclosure, different types of trigger points are configured in the microkernel based on actual usage requirements. A trigger event refers to a specific event caused by a trigger point, which requires response and handling from the microkernel. The trigger event typically includes information such as a type of the event and parameters of the event, which information is used by the microkernel to determine how to handle the event.

In FIG. 2, the trigger point triggered by the microkernel to execute the Wasm bytecode may be configured by a thread. The trigger point may include an interrupt trigger point, an IPC trigger point, or an active invocation trigger point. Correspondingly, the trigger event may be an interrupt event corresponding to the interrupt trigger point, an IPC event corresponding to the IPC trigger point, or an active invocation event corresponding to the active invocation trigger point.

The embodiments disclosed herein may be applied to various usage scenarios such as interrupt handling, IPC communication, and user-mode active invocation. The application is flexible and highly scalable.

Said acquiring the Wasm bytecode associated with the trigger event includes: acquiring the Wasm bytecode associated with the trigger event for the trigger event corresponding to different types of trigger points.

After performing the second step in 101, the method further includes: loading the Wasm bytecode from the shared code region; and confifiguring an association between the trigger event and the Wasm bytecode.

Here, configuring the association between the trigger event and the Wasm bytecode may refer to configuring an association between different types of trigger points and corresponding Wasm bytecodes.

In the embodiment of the present disclosure, to ensure security of the Wasm bytecode, the Wasm bytecode in the shared code region is verified, and the Wasm bytecode is loaded from the shared code region merely after successful verification.

Verifying the Wasm bytecode includes verifying whether Wasm conforms to at least one of the following: accessing the shared code region using a native function interface; prohibiting a function pointer from being used for function access; preventing injection of an infinite loop code; or limiting a number of lines of an injected code.

The native function interface is used to access a shared memory and object. The native function interface includes at least one of the following: (1) a function interface for writing bytes to a location offset from the shared data region associated with the Wasm bytecode; a function interface for reading bytes from the location offset from the shared data region associated with the Wasm bytecode; or a function interface for obtaining length of the shared data region associated with the Wasm bytecode; (2) a function interface for serial port printing and character acquisition; (3) a function interface for outputting characters to a serial port; or (4) a function interface for obtaining an offset-th parameter of the input passed in by active invocation.

In the embodiment of the present disclosure, after the Wasm bytecode is verified, the shared code region written with the Wasm bytecode is instantiated to acquire an instantiated shared code region object.

Following acquiring the instantiated shared code region object, configuring the association between the trigger event and the Wasm bytecode includes configuring the association between the trigger event and the instantiated shared code region object.

In the embodiment of the present disclosure, for the active invocation trigger point, user-mode active control of execution of the Wasm bytecode is implemented through the active invocation interface, with input parameters including permission of the shared memory and 4 input parameters.

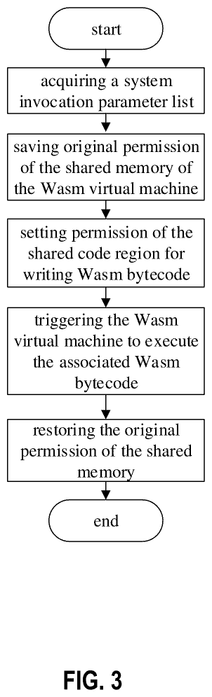

In FIG. 3, implementing the user-mode active control of the Wasm virtual machine to execute the Wasm bytecode through active interface invocation includes: (1) acquiring a system invocation parameter list used to define parameters of the active invocation interface; (2) saving original permission of the shared memory of the Wasm virtual machine; (3) setting permission of the shared code region for writing Wasm bytecode; (4) triggering the Wasm virtual machine to execute the associated Wasm bytecode; and (5) restoring the original permission of the shared memory.

In conjunction with embodiments, the above step 103, i.e., “the virtual machine is controlled to execute the bytecode, and an execution result of the preset trigger event is written into a shared data region, to make the execution result be read from the shared data region in the user mode after switching to the user mode”, is described in detail below.

In the embodiment of the present disclosure, the Wasm virtual machine is controlled to execute the Wasm bytecode and the execution result is written into the shared data region so that the execution result can be read from the shared data region in the user mode after switching to user mode.

In one example, the trigger event includes active invocation events corresponding to different threads in the target application program.

Said controlling the Wasm virtual machine to execute the bytecode, and writing the execution result of the preset trigger event into the shared data region includes: for different threads, controlling the same Wasm virtual machine to execute the same Wasm bytecode, and writing execution results of the active invocation events corresponding to different threads into different shared data regions.

In the embodiment of the present disclosure, for active invocation events corresponding to different threads in the target application program, the same Wasm virtual machine is invoked to execute the same Wasm bytecode, and the execution results of the active invocation events corresponding to different threads are written into different shared data regions. The different shared data regions are configured by the active invocation interface.

In response to the trigger point being an active invocation trigger point, the Wasm bytecode associated with the active invocation trigger point is pre-written into the shared code region (shown as “shared code region” in FIG. 2), and the execution result corresponding to the active invocation trigger point is written into the shared data region. The shared data region may be a default shared memory set during configuration, or may be shared data memory created in other user modes. The actual shared data region used by each language interpreter may be configured through system invocation, thus separating the Wasm bytecode and the execution result so that they do not affect each other.

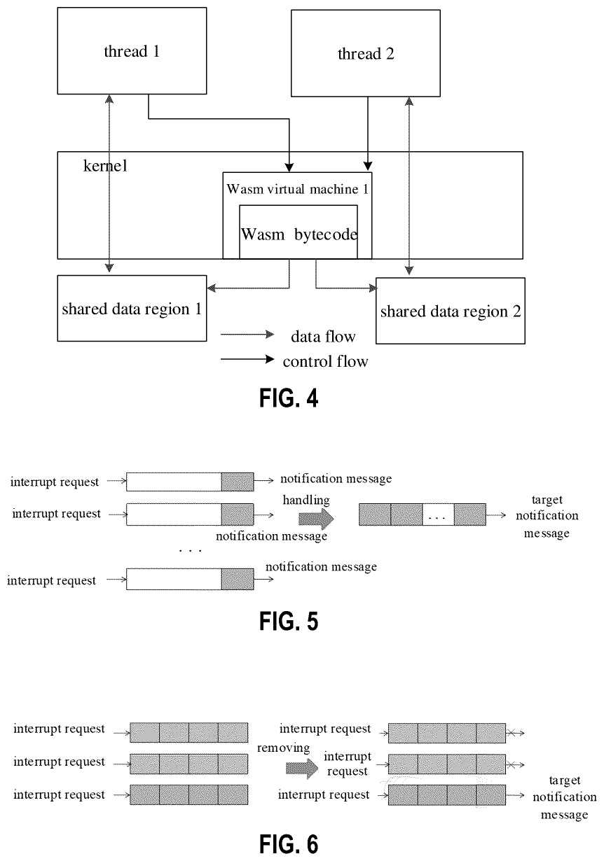

In this scenario, as shown in FIG. 4, an example of thread 1 and thread 2 actively invoking the same Wasm virtual machine is shown.

When thread 1 and thread 2 actively access the same Wasm virtual machine, the same associated Wasm bytecode is executed by the Wasm. The execution result of the active invocation event corresponding to the thread 1 is written to shared data region 1, and the execution result of the active invocation event corresponding to the thread 2 is written to shared data region 2. This allows reuse of the same Wasm bytecode. In addition, as the Wasm bytecode and the execution result are separated, they do not affect each other during the reuse. In FIG. 4, red arrows represent data flow, and black arrows represent control flow.

It should be noted that active invocation refers to a target application program running in the user mode actively invoking services or functions provided by the microkernel, including access to different shared data regions in the shared memory. In the kernel mode, for different threads in the target application program running in the user mode, the same Wasm virtual machine embedded in the microkernel is controlled to execute the same Wasm bytecode, and the execution results for different threads are written into different shared data regions. In the embodiment of the present disclosure, the microkernel is accessed through active invocation, which allows dynamic injection of codes (i.e., Wasm bytecode) that a user needs to extendedly execute within the microkernel. This dynamic injection method avoids recompiling of the microkernel each time, thereby improving development efficiency and scalability of the microkernel.

It is explained below how to improve the handling efficiency of the microkernel system by taking an interrupt trigger point as an example.

For the interrupt trigger point, take an interrupt event driven by a CAN bus as an example. Read and write operations in the interrupt event are executed by the Wasm virtual machine within the microkernel, and data is copied to the shared data region. After handling the interrupt event (e.g., reading data), the Wasm virtual machine writes the execution result (i.e., the read data) into the shared data region. The Wasm virtual machine no longer sends a notification message to a CAN driver, and the CAN driver can read data stored in the shared data region as needed.

In relevant technologies, a microkernel interrupt process starts from entering microkernel interrupt handling and ends when the user mode resumes interrupt. A time period for the microkernel interrupt process includes IPC notification time, system context switching, and handling time of the interrupt event driven by CAN.

In the embodiment of the present disclosure, an interrupt process using the Wasm virtual machine starts from entering microkernel interrupt handling and ends when the microkernel interrupt handling is completed. A time period for the interrupt process using the Wasm virtual machine includes time Wasm prepares for running and handling time of the interrupt event driven by CAN.

As can be seen, in a single interrupt event driven by CAN, the usage of the microkernel Wasm virtual machine saves more communication time compared to the Wasm virtual machine in related technologies due to reduced IPC notification time and context switching, thereby improving the handling efficiency of the microkernel system. Taking this as an example, in other scenarios with frequent interrupt events, considerable performance advantages may be brought to the microkernel system.

In one example, following writing the execution result of the trigger event to the shared data region, the method further includes: generating at least one notification message in response to the trigger event; and sending the at least one notification message, to make the execution result be read from the shared data region based on the at least one notification message in the user mode after switching to the user mode.

In the embodiment of the present disclosure, after acquiring the execution result of the trigger event, a notification message is generally sent to the user-mode thread in response to the trigger event, so that after switching to the user mode, the execution result can be read from the shared data region in the user mode based on the notification message.

In one example, for a scenario where multiple trigger events are detected, generating at least one notification message in response to the trigger events includes generating separate notification messages for each of the multiple trigger events.

In the scenario where multiple trigger events are detected, after acquiring the execution result of the trigger events, the notification message is generally sent to the user-mode thread for each trigger event. In the embodiment of the present disclosure, handling of the notification message, which was originally performed in the user mode, may be moved to the microkernel. Prior to sending the notification message to the user-mode thread, the notification message of each trigger event is handled in the kernel mode.

If multiple trigger events exist, multiple notification messages are generated (one notification message for each trigger event). As one possible implementation, said handling the notification message of each trigger event may include: merging multiple notification messages generated into a single target notification message.

In the embodiment of the present disclosure, the target notification message is determined based on the notification message corresponding to each of the multiple trigger events, and the number of the target notification message is less than the number of the notification messages corresponding to the multiple trigger events. Compared to sending notification messages to the user mode separately for each trigger event, only sending the target notification message to the user mode eliminates switching between the user mode and the kernel mode for each notification message corresponding to each trigger event, thereby improving the handling efficiency of the microkernel system.

In one example, the target notification message is a single notification message.

In the embodiment of the present disclosure, when seL4 handles the interrupt event, seL4 sends a notification message to the user mode. Before seL4 sends the notification message to the user mode, the Wasm virtual machine preprocesses the notification message, for example, by merging the notification message for each interrupt event into a single target notification message. This eliminates switching between the user mode and the kernel mode for the notification message of each trigger event, thereby improving the handling efficiency of the microkernel system.

In FIG. 5, an interruption event is taken as an example.

In response to an Interrupt ReQuest (IRQ) corresponding to each interrupt event being detected during the running of the target application program, the notification message corresponding to each interrupt request is merged into a single target notification message. In this manner, only one target notification message is sent to the user mode, eliminating switching between the user mode and the kernel mode for the notification message of each interrupt event, thereby improving the handling efficiency of the microkernel system.

If multiple trigger events exist, multiple notification messages are generated. As one possible implementation, said handling the notification message of each trigger event may include: removing, from the multiple notification messages, partial notification messages not required by the user mode to acquire the target notification message.

In the embodiment of the present disclosure, the messages that are removed from gateway messages in the user mode are moved to the microkernel. The user mode removes partial notification messages from the notification messages corresponding to the multiple trigger events to acquire the target notification message. This eliminates switching to the user mode to remove these messages, thereby improving the handling efficiency of the microkernel system.

In FIG. 6, an interruption event is taken as an example.

During the running of the target application program, in response to detecting the IRQ corresponding to each interrupt event, the two IRQs in yellow strips are removed, and only a notification message corresponding to the IRQ in a green strip is sent to the user mode. This eliminates switching between the user mode and the kernel mode for the notification messages corresponding to the interrupt events in the yellow strips, thereby improving the handling efficiency of the microkernel system.

It is explained below how to improve the handling efficiency of the microkernel system by taking an IPC trigger point for example.

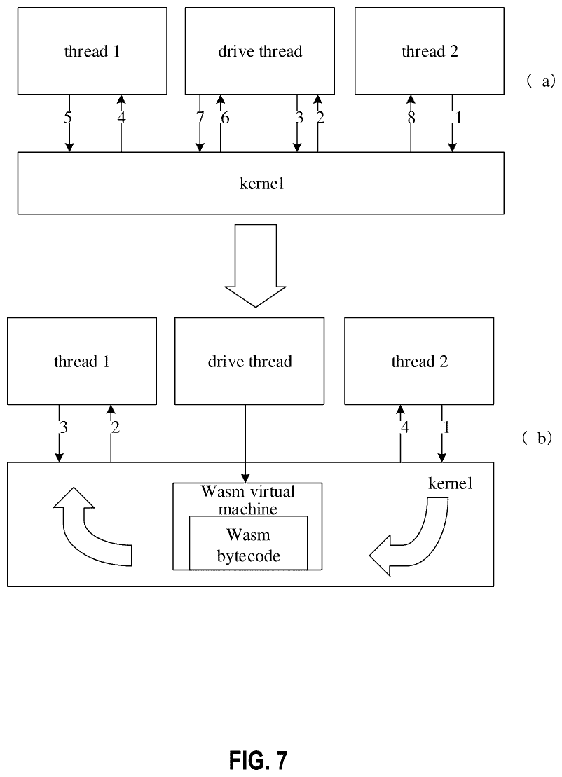

In FIG. 7, a Driver (DRV) thread is a process within a drive program. A thread is a smallest unit that can be computed and scheduled in an operating system (i.e., the microkernel system). Thread 1 and Thread 2 are threads that run in the user mode for the target application program. The threads are contained within the process and are actual units of operation within the process. The Wasm virtual machine is embedded in the microkernel.

When the target application program in the user mode needs to perform low-level operations such as input/output or applying for memory, an Application Programming Interface (API) function provided by the operating system must be invoked to enter the kernel mode. After the operation is completed, it switches back to the user mode.

FIG. 6(a) illustrates a traditional implementation manner, where thread 1, thread 2 and a drive thread are thread 1, thread 2 and the drive thread in the user mode, respectively.

Input/output operations corresponding to IPC events between Thread 1, Thread 2, and the drive thread and the microkernel are taken as an example for explanation below. A communication process between Thread 1, Thread 2, and the drive thread and the microkernel includes following steps.
(1) Before thread 2 performs the output operation to the microkernel, it first switches from the user mode to the kernel mode (corresponding to “1” in FIG. 6(a)).
(2) After the microkernel handles the output operation of thread 2, the microkernel performs the input operation to the drive thread. Before performing the input operation, it switches from the kernel mode to the user mode (corresponding to “2” in FIG. 6(a)).
(3) After the drive thread handles the input operation and before the drive thread performs the output operation to the microkernel, it first switches from the user mode to the kernel mode (corresponding to “3” in FIG. 6(a)).
(4) After the microkernel handles the output operation of the drive thread and before the microkernel performs the input operation to thread 1, it switches from the kernel mode to the user mode (corresponding to “4” in FIG. 6(a)).
(5) After thread 1 handles the output operation of the microkernel, before thread 1 performs the output operation to the microkernel, it first switches from the user mode to the kernel mode (corresponding to “5” in FIG. 6(a)).
(6) After the microkernel handles the output operation of thread 1, before the microkernel performs the input operation to the drive thread, it switches from the kernel mode to the user mode (corresponding to “6” in FIG. 6(a)).
(7) After the drive thread handles the input operation of the microkernel in (6) and before the drive thread performs the output operation to the microkernel, it first switches from the user mode to the kernel mode (corresponding to “7” in FIG. 6(a)).
(8) The microkernel handles the output operation of the drive thread in (7), performs the input operation on thread 2, and switches from the kernel mode to the user mode before performing the input operation (corresponding to “8” in FIG. 6(a)).

The above process indicates that a total of 8 switches are made between the user mode and the kernel mode.

The following description refers to FIG. 6(b). FIG. 6(b) illustrates the manner provided by the embodiments of the present disclosure, in which operations (such as input and output operations) performed by the drive thread are moved to the microkernel and executed by the Wasm virtual machine embedded in the microkernel. In this manner, communication between threads and mode switching can be reduced from the original 8 times to 4 times.

In the above process, a code corresponding to part or all of the drive thread is used as input into a functional code of the microkernel. The user mode moves the operations of the drive thread to the microkernel through IPC events, reducing 4 switches between the kernel mode and the user mode, thereby improving the handling efficiency of the microkernel system.

In the embodiment of the present disclosure, prior to 103, the method further includes: configuring attributes of the Wasm virtual machine through a configuration interface, such as configuring a data structure of the Wasm virtual machine, where the data structure of the Wasm virtual machine includes a shared data region base address, a shared code region base address, a shared data region length, and a shared code region length.

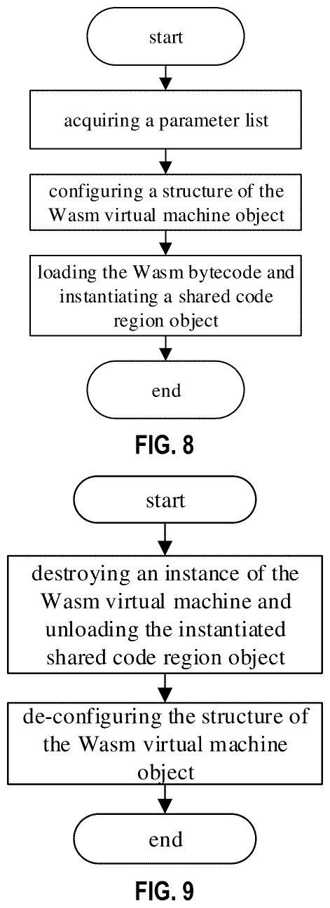

In one example, as shown in FIG. 8, configuring attributes of a Wasm virtual machine object includes following steps: (1) acquiring a parameter list which includes parameters related to the attributes of the virtual machine object; (2) configuring a structure of the Wasm virtual machine object; and (3) loading the Wasm bytecode and instantiating a shared code region object.

In the embodiment of the present disclosure, the attributes of the Wasm virtual machine object may be cleared via an interface for deconfiguration.

In FIG. 9, said clearing the attributes of the Wasm virtual machine object via the interface for deconfiguration includes following steps: (1) destroying an instance of the Wasm virtual machine and unloading the instantiated shared code region object; and (2) de-configuring the structure of the Wasm virtual machine object.

In the embodiment of the present disclosure, the Wasm virtual machine integrated into SeL4 is employed. The Wasm virtual machine is abstracted as an object within the microkernel, and its permission is used to control access to the Wasm virtual machine by the user mode, thereby ensuring security of the microkernel. Any user mode with the permission can use the Wasm virtual machine object. Therefore, a new Wasm virtual machine object needs to be added in the microkernel system.

An association between the trigger event and the Wasm bytecode is configured, which includes: creating a Wasm virtual machine object for the target application program, configuring the Wasm virtual machine object using information from the shared code region and shared data region; and configuring an association between the trigger event and permission of the Wasm virtual machine object.

Said configuring the association between the trigger event and the permission of the Wasm virtual machine object refers to configuring an association between different types of trigger points and the permission of the Wasm virtual machine object.

For example, an association between an interrupt trigger point and specified permission of the Wasm virtual machine object is configured.

For example, an association between an IPC trigger point and specified permission of the Wasm virtual machine object is configured.

Correspondingly, in the example, the association between the interrupt trigger point and the specified permission of the Wasm virtual machine object may be cleared.

Correspondingly, in the example, the association between the IPC trigger point and the specified permission of the Wasm virtual machine object may be cleared.

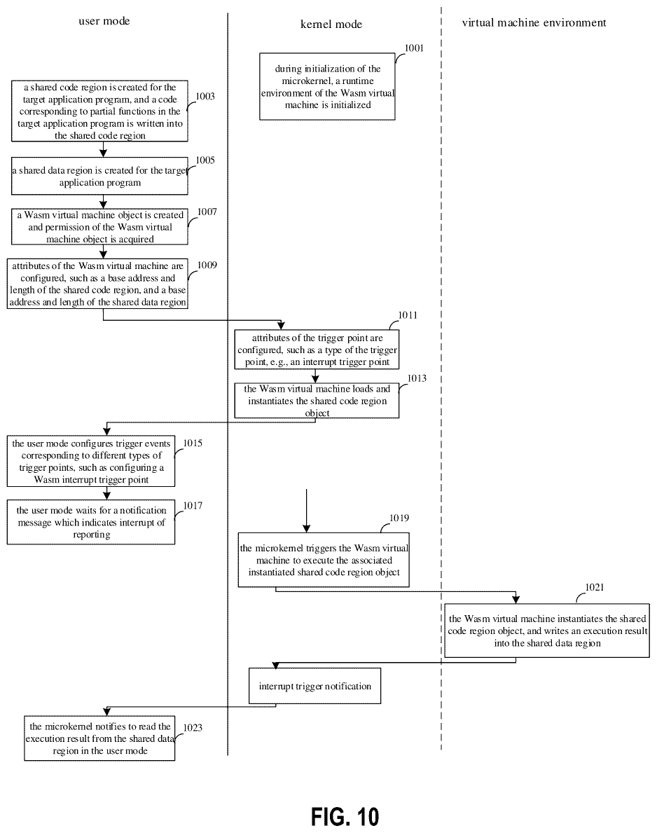

FIG. 10 is a flow chart of a microkernel-based event handling method provided in an embodiment of the present disclosure. Referring to FIG. 10, taking an interrupt trigger point as an example, the microkernel-based event handling method in the embodiment of the present disclosure may include 1001 to 1023.

In 1001, during initialization of the microkernel, a runtime environment of the Wasm virtual machine is initialized (i.e., initializing the runtime environment for running the Wasm virtual machine).

In 1003, a shared code region is created for the target application program, and a code corresponding to partial functions in the target application program is written into the shared code region.

In 1005, a shared data region is created for the target application program.

In 1007, a Wasm virtual machine object is created and permission of the Wasm virtual machine object is acquired.

In the embodiment of the present disclosure, system invocation is used to configure permission of a shared memory to the Wasm virtual machine object. The configuration process involves entering a microkernel, where configuration variables are stored in the microkernel, the Wasm bytecode is loaded from the shared code region, and the Wasm bytecode is instantiated upon successful verification.

In 1009, attributes of the Wasm virtual machine are configured, such as a base address and length of the shared code region, and a base address and length of the shared data region.

In 1011, attributes of the trigger point are configured, such as a type of the trigger point, e.g., an interrupt trigger point.

In 1013, the Wasm virtual machine loads and instantiates the shared code region object.

In 1015, the user mode configures trigger events corresponding to different types of trigger points, such as configuring a Wasm interrupt trigger point.

In 1017, the user mode waits for a notification message which indicates interrupt of reporting.

In 1019, in response to interrupt hardware trigger being configured (i.e., the interrupt trigger point being detected), the microkernel triggers the Wasm virtual machine to execute the associated instantiated shared code region object.

In 1021, the Wasm virtual machine instantiates the shared code region object, and writes an execution result into the shared data region. The Wasm virtual machine exits after execution.

In 1023, the microkernel notifies to read the execution result from the shared data region in the user mode.

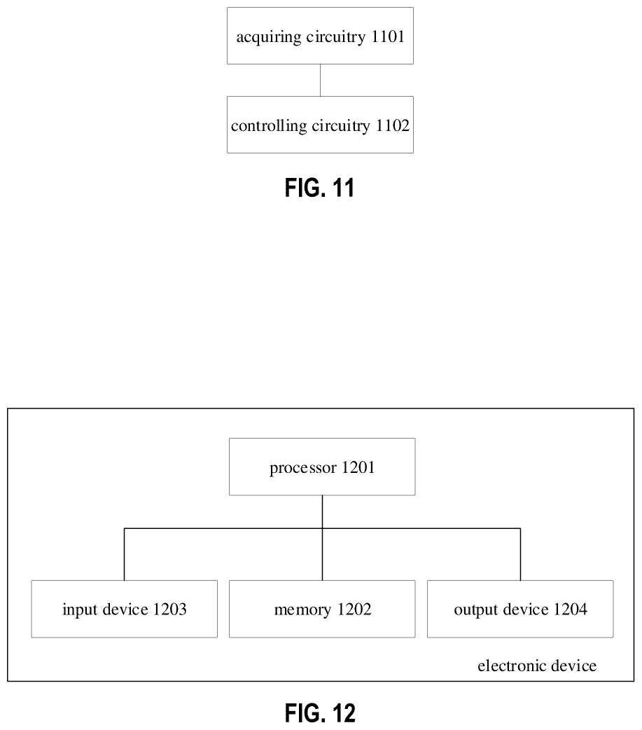

Method embodiments of the present disclosure have been described in detail above with reference to FIG. 1. Apparatus embodiments of the present disclosure are described in detail below with reference to FIG. 11. It should be understood that the descriptions of the method embodiments correspond to the descriptions of the apparatus embodiments. Therefore, any parts not described in detail can be referred to the foregoing method embodiments.

FIG. 11 is a block diagram of a microkernel-based event handling apparatus provided in an embodiment of the present disclosure. As shown in FIG. 11, the microkernel-based event handling apparatus provided in the embodiment of the present disclosure has a virtual machine embedded in the microkernel. The apparatus includes an acquiring circuitry 1101 and a controlling circuitry 1102. The acquiring circuitry 1101 is configured to: in response to detecting a preset trigger event during running of a target application program in a user mode, switch from the user mode to a kernel mode and acquire a bytecode associated with the preset trigger event, where the bytecode is a functional code pre-written into a shared code region in the user mode, and the functional code is a code corresponding to partial functions in the target application program. The controlling circuitry 1102 is configured to: control the virtual machine to execute the bytecode, and write an execution result of the preset trigger event into a shared data region, to make the execution result be read from the shared data region in the user mode after switching to the user mode.

In some embodiments, the apparatus further includes: a message generating circuitry (not shown) configured to: after the execution result of the preset trigger event is written into the shared data region, generate at least one notification message in response to the preset trigger event; and a message notifying circuitry (not shown) configured to: send the at least one notification message, to make the execution result be read from the shared data region based on the at least one notification message in the user mode after switching to the user mode.

In some embodiments, the preset trigger event includes a plurality of trigger events, and the message generating circuitry is further caused to: generate a plurality of notification messages for the plurality of trigger events respectively.

In some embodiments, the message notifying circuitry is further configured to: merge the plurality of notification messages into a single target notification message, and/or, remove, from the plurality of notification messages, partial notification messages not required by the user mode to acquire a target notification message; and send the target notification message.

In some embodiments, the preset trigger event includes: an interrupt event, an IPC event, or an active invocation event.

In some embodiments, the preset trigger event includes active invocation events corresponding to different threads in the target application program. The controlling circuitry 1102 is further configured to: for different threads, control the same virtual machine to execute the bytecode, and write execution results of the active invocation events corresponding to different threads into different shared data regions.

In some embodiments, in response to the preset trigger event being an IPC event, the functional code includes a code corresponding to a drive thread or all of codes.

In some embodiments, the interrupt event includes an interrupt event driven by CAN.

In some embodiments, the apparatus further includes: a loading circuitry configured to: before the preset trigger event during running of the target application program in the user mode is detected, load the bytecode from the shared code region; and a configuring circuitry configured to configure an association between the preset trigger event and the bytecode.

In some embodiments, the loading circuitry is further configured to: verify the bytecode; and in response to the bytecode being successful verified, load the bytecode from the shared code region.

In some embodiments, said verifying the bytecode includes verifying whether the bytecode conforms to at least one of the following: accessing the shared code region using a native function interface; prohibiting a function pointer from being used for function access; preventing injection of an infinite loop code; or limiting a number of lines of an injected code.

In some embodiments, the apparatus further includes: an initializing circuitry configured to: before the preset trigger event during running of the target application program in the user mode is detected, initialize a runtime environment of the virtual machine; and a creating circuitry configured to: create a shared code region for the target application program, write the code corresponding to the partial functions in the target application program into the shared code region, and create the shared data region for the target application program.

In some embodiments, the configuring circuitry is further configured to: create a virtual machine object for the target application program, and configure the virtual machine object using information of the shared code region and the shared data region; and configure an association between the preset trigger event and the virtual machine object.

In some embodiments, the bytecode is a Wasm bytecode, a Lua bytecode, or a eBPF bytecode.

Hereinafter, an electronic device according to an embodiment of the present disclosure is described with reference to FIG. 12. FIG. 12 is a block diagram of an electronic device provided in an embodiment of the present disclosure.

As shown in FIG. 12, the electronic device includes one or more processors 1201 and a memory 1202.

The processor 1201 may be a Central Processing Unit (CPU) or other forms of processing units with data processing capability and/or instruction execution capability, and may control other components in the electronic device to perform desired functions.

The memory 1202 may include one or more computer program products, which may include various forms of computer-readable storage media, such as volatile memory and/or non-volatile memory. The volatile memory may include, for example, Random Access Memory (RAM) and/or cache. The non-volatile memory may include, for example, Read Only Memory (ROM), hard disk, flash memory, etc. One or more computer program instructions may be stored on the computer-readable storage medium, and the processor 1201 may execute the program instructions to implement functions such as the microkernel-based event handling methods in the various embodiments of the present disclosure. Various contents such as bytecode may also be stored in the computer-readable storage medium.

In one example, the electronic device may further include an input device 1203 and an output device 1204, which are interconnected via a bus system and/or other forms of connection mechanism (not shown).

The input device 1203 may include, for example, a keyboard, a mouse, etc.

The output device 1204 may output various information, including the execution result. The output device 1204 may include, for example, a display, a speaker, a printer, and a communication network and its connected remote output devices, etc.

For simplicity, FIG. 12 merely shows some of the components in the electronic device that are relevant to the present disclosure, omitting components such as buses, input/output interfaces, etc. In addition, the electronic device may include any other suitable components depending on specific application.

In addition to the methods and apparatus described above, the embodiments of the present disclosure may also be a computer program product including computer program instructions that, when executed by a processor, cause the processor to perform steps in the microkernel-based event handling methods according to the various embodiments of the present disclosure.

The computer program product may use any combination of one or more programming languages to write program codes that perform operations of the embodiments of the present disclosure. The programming languages include object-oriented programming languages such as Java and C++, as well as conventional procedural programming languages such as C or similar languages. The program codes may be executed entirely or partially on an electronic device of a user, as a standalone software package, partially on the electronic device of the user and partially on a remote electronic device, or entirely on the remote electronic device or a server.

Further, the embodiments of the present disclosure may also be a computer-readable storage medium storing computer program instructions that, when executed by a processor, cause the processor to perform the steps in the microkernel-based event handling methods according to the various embodiments of the present disclosure.

The computer-readable storage medium may take the form of any combination of one or more readable media. The readable media may include a readable signal medium or a readable storage medium. The readable storage medium may include, for example, but is not limited to, electrical, magnetic, optical, electromagnetic, infrared, or semiconductor systems, apparatuses, devices, or any combination thereof. More specific examples of the readable storage medium (a non-exhaustive list) include: electrical connections having one or more wires, portable disk, hard disk, RAM, ROM, Erasable Programmable ROM (EPROM or flash memory), optical fiber, portable Compact Disk ROM (CD-ROM), optical storage device, magnetic storage device, or any suitable combination thereof.

Basic principles of the present disclosure have been described above with reference to specific embodiments. However, it should be noted that the advantages, benefits, and effects mentioned in the present disclosure are merely examples but not limitations, and should not be considered as essential features of each embodiment of the present disclosure. In addition, the specific details disclosed above are for illustrative and facilitative purposes only, but not limitations. These details do not limit the scope of the present disclosure to the necessity of employing the aforementioned specific details for implementation.

The block diagrams of devices, apparatuses, devices, and systems disclosed herein are merely illustrative examples and are not intended to require or imply that they must be connected, arranged, or configured in the manner shown in the block diagrams. As those skilled in the art can recognize, these devices, apparatuses, devices, and systems can be connected, arranged, and configured in any manner. Words such as “comprising”, “including”, “having”, etc., are open-ended terms meaning “including but not limited to”, and are used interchangeably with them. The terms “or” and “and” as used herein refer to the terms “and/or”, and are used interchangeably with them unless the context clearly indicates otherwise. The term “such as” as used herein refers to a phrase “such as but not limited to”, and is used interchangeably with it.

It should also be noted that in the apparatus, devices, and methods of the present disclosure, the components or steps can be disassembled and /r recombined. The disassembly and/or recombination should be considered as equivalent solutions to the present disclosure.

The above description of the disclosed aspects is provided to enable those skilled in the art to make or use the present disclosure. Various modifications to these aspects will be readily apparent to those skilled in the art, and general principles defined herein may be applied to other aspects without departing from the scope of the present disclosure. Therefore, the present disclosure is not intended to be limited to the aspects shown herein, but rather to be carried out within the widest scope consistent with the principles and novel features disclosed herein.

The above description has been given for purposes of illustration and description. In addition, the description is not intended to limit the embodiments of the present disclosure to the forms disclosed herein. Although numerous exemplary aspects and embodiments have been discussed above, those skilled in the art can recognize variations, modifications, alterations, additions, and sub-combinations therein.

The above description includes merely preferred embodiments of the present disclosure, but is not intended to limit the present disclosure. Any modifications or equivalent substitutions made within the spirit and principles of the present disclosure should be included within the scope of the present disclosure.

What is claimed is:

1. A microkernel-based event handling method, wherein a microkernel is embedded with a virtual machine, and the method comprises:
in response to detecting a preset trigger event during running of a target application program in a user mode, switching from the user mode to a kernel mode and acquiring a bytecode associated with the preset trigger event, wherein the bytecode is a functional code pre-written into a shared code region in the user mode, and the functional code is a code corresponding to partial functions in the target application program; and
controlling the virtual machine to execute the bytecode, and writing an execution result of the preset trigger event into a shared data region, to make the execution result be read from the shared data region in the user mode after switching to the user mode.

2. The method according to claim 1, wherein following writing the execution result of the preset trigger event into the shared data region, the method further comprises:
generating at least one notification message in response to the preset trigger event; and
sending the at least one notification message, to make the execution result be read from the shared data region based on the at least one notification message in the user mode after switching to the user mode.

3. The method according to claim 2, wherein the preset trigger event comprises a plurality of trigger events, and said generating the at least one notification message in response to the preset trigger event comprises: generating a plurality of notification messages for the plurality of trigger events respectively.

4. The method according to claim 3, wherein sending the notification message comprises:
merging the plurality of notification messages into a single target notification message, and/or, removing, from the plurality of notification messages, partial notification messages not required by the user mode to acquire a target notification message; and
sending the target notification message.

5. The method according to claim 2, wherein prior to said detecting the preset trigger event during running of the target application program in the user mode, the method further comprises:
initializing a runtime environment of the virtual machine;
creating a shared code region for the target application program, and writing the code corresponding to the partial functions in the target application program into the shared code region; and
creating the shared data region for the target application program.

6. The method according to claim 1, wherein the preset trigger event comprises: an interrupt event, an Inter-Process Communication (IPC) event, or an active invocation event.

7. The method according to claim 6, wherein the preset trigger event comprises active invocation events corresponding to different threads in the target application program; and
said controlling the virtual machine to execute the bytecode, and writing the execution result of the preset trigger event into the shared data region comprises: for different threads, controlling the same virtual machine to execute the bytecode, and writing execution results of the active invocation events corresponding to different threads into different shared data regions.

8. The method according to claim 6, wherein in response to the preset trigger event being an IPC event, the functional code comprises a code corresponding to a drive thread or all of codes.

9. The method according to claim 6, wherein the interrupt event comprises an interrupt event driven by CAN.

10. The method according to claim 1, wherein prior to detecting the preset trigger event during running of the target application program in the user mode, the method further comprises:
loading the bytecode from the shared code region; and
configuring an association between the preset trigger event and the bytecode.

11. The method according to claim 10, wherein said loading the bytecode from the shared code region comprises:
verifying the bytecode; and
in response to the bytecode being successful verified, loading the bytecode from the shared code region.

12. The method according to claim 11, wherein said verifying the bytecode comprises verifying whether the bytecode conforms to at least one of the following:
accessing the shared code region using a native function interface;
prohibiting a function pointer from being used for function access;
preventing injection of an infinite loop code; or
limiting a number of lines of an injected code.

13. The method according to claim 10, wherein said configuring the association between the preset trigger event and the bytecode comprises:
creating a virtual machine object for the target application program, and configuring the virtual machine object using information of the shared code region and the shared data region; and
configuring an association between the preset trigger event and the virtual machine object.

14. The method according to claim 1, wherein prior to said detecting the preset trigger event during running of the target application program in the user mode, the method further comprises:
initializing a runtime environment of the virtual machine;
creating a shared code region for the target application program, and writing the code corresponding to the partial functions in the target application program into the shared code region; and
creating the shared data region for the target application program.

15. The method according to claim 1, wherein the bytecode is a Wasm bytecode, a Lua bytecode, or an eBPF bytecode.

16. An electronic device comprising a memory and a processor, wherein the memory stores one or more programs, the one or more programs comprising computer instructions, which, when executed by the processor, cause the processor to:
in response to detecting a preset trigger event during running of a target application program in a user mode, switch from the user mode to a kernel mode and acquire a bytecode associated with the preset trigger event, wherein the bytecode is a functional code pre-written into a shared code region in the user mode, and the functional code is a code corresponding to partial functions in the target application program; and
control the virtual machine to execute the bytecode, and write an execution result of the preset trigger event into a shared data region, to make the execution result be read from the shared data region in the user mode after switching to the user mode.

17. The electronic device of claim 16, wherein the instructions further cause the processor to:
prior to said detecting the preset trigger event during running of the target application program in the user mode:
initialize a runtime environment of the virtual machine;
create a shared code region for the target application program, and writing the code corresponding to the partial functions in the target application program into the shared code region; and
create the shared data region for the target application program.

18. A non-transitory computer-readable storage medium storing one or more programs, the one or more programs comprising computer instructions, which, when executed by a processor, cause the processor to:
in response to detecting a preset trigger event during running of a target application program in a user mode, switch from the user mode to a kernel mode and acquire a bytecode associated with the preset trigger event, wherein the bytecode is a functional code pre-written into a shared code region in the user mode, and the functional code is a code corresponding to partial functions in the target application program; and
control the virtual machine to execute the bytecode, and write an execution result of the preset trigger event into a shared data region, to make the execution result be read from the shared data region in the user mode after switching to the user mode.

19. The non-transitory computer-readable storage medium of claim 18, wherein the instructions further cause the processor to:
prior to said detecting the preset trigger event during running of the target application program in the user mode:
initialize a runtime environment of the virtual machine;
create a shared code region for the target application program, and writing the code corresponding to the partial functions in the target application program into the shared code region; and
create the shared data region for the target application program.
